(19) United States
(12) Patent Application Publication
(10) Pub. No.: US 2013/0212210 A1
(43) Pub. Date: Aug. 15, 2013

(54) RULE ENGINE MANAGER IN MEMORY DATA TRANSFERS

(71) Applicants: Paul Deforest Bell, Marietta, GA (US); Leon Ericson Haynes, Virginia Beach, VA (US); Timothy Walker Stoke, Virginia Beach, VA (US)

(72) Inventors: Paul Deforest Bell, Marietta, GA (US); Leon Ericson Haynes, Virginia Beach, VA (US); Charles Brian Singleton, Newport News, VA (US); Timothy Walker Stoke, Virginia Beach, VA (US)

(73) Assignee: General Electric Company, Schenectady, NY (US)

(21) Appl. No.: 13/370,700

(22) Filed: Feb. 10, 2012

(51) Int. Cl. G06F 15/167

(52) U.S. Cl. 709/214

(57) ABSTRACT

A rule engine manager in-memory data transfer system includes a rule engine manager cluster, a first memory cache coupled to the rule engine manager cluster, a data server cluster coupled to the rule engine manager cluster and a second memory cache coupled to the data server cluster.

### BACKGROUND OF THE INVENTION

The subject matter disclosed herein relates to computer data transfers and more particularly to systems and methods having a rule engine manager for in-memory data transfers that bypass input/output (I/O) operations.

An analysis engine (AE) is an algorithm that takes data from a log file (e.g., data related to a turbine fleet), compares it to rules or a set of rules in a symptom database, and returns an array of objects representing the solutions and directives for the matched symptoms.

Currently, acquiring the various data types required for an AE to run (e.g., input\output time series data, state file data, and rule set data) are written\retrieved by the AE to\from a computers file system that may or not may be local to the AE. For a write of data the AE is responsible for accessing the file location, taking the data in its memory and producing a file in the proper format. In addition, the AE is responsible for calling on the OS services to write to disk (i.e., I/O). Likewise, for retrieving data the AE has to access the file location, read the file into memory using OS services, and then manipulate the data so that it can be used by the AE. All of these actions are performed by the AE and require a large amount of non-value work and computer processing lengthening the time to recognition of when an event of interest occurred and when it was recognized by the system. The AE also has instances when it fails to run because of being unable to access file locations for reading the data.

### BRIEF DESCRIPTION OF THE INVENTION

According to one aspect of the invention, a rule engine manager in-memory data transfer system is described. The system includes a rule engine manager cluster, a first memory cache coupled to the rule engine manager cluster, a data server cluster coupled to the rule engine manager cluster and a second memory cache coupled to the data server cluster.

According to another aspect of the invention, a data transfer method is described. The method includes transferring time series data between a rule engine manager and an analysis engine, transferring state file data between the rule engine manager and the analysis engine, and transferring rule logic data between the rule engine manager and the analysis engine.

According to yet another aspect of the invention, a computer program product for transferring data is described. The computer program product includes a non-transitory computer readable medium storing instructions for causing a computer to implement a method. The method includes transferring time series data between a rule engine manager and an analysis engine, transferring state file data between the rule engine manager and the analysis engine, and transferring rule logic data between the rule engine manager and the analysis engine.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 illustrates a system level diagram of an exemplary rule engine manager in-memory data transfer system;

FIG. 2 illustrates a flow chart for a method of in-memory data transfer of input and output time series data in accordance with exemplary embodiments;

FIG. 3 illustrates a flow chart for a method of in-memory data transfer of state files in accordance with exemplary embodiments;

FIG. 4 illustrates a flow chart for a method of in-memory data transfer of rule logic data in accordance with exemplary embodiments; and

FIG. 5 illustrates an exemplary embodiment of a system for rule engine manager in-memory data transfer.

The detailed description explains embodiments of the invention, together with advantages and features, by way of example with reference to the drawings.

### DETAILED DESCRIPTION OF THE INVENTION

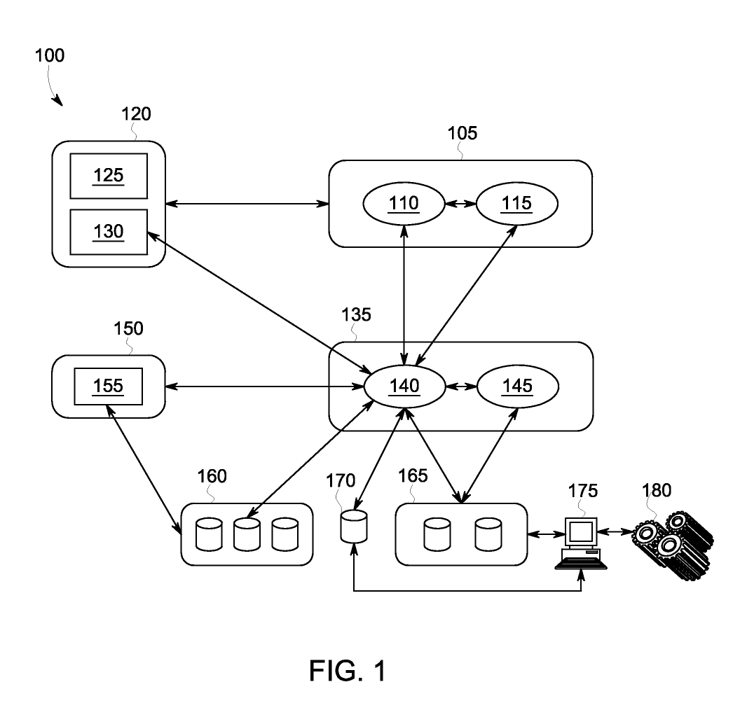

FIG. 1 illustrates a system level diagram of an exemplary rule engine manager in-memory data transfer system 100. In exemplary embodiments, the system 100 includes a rule engine manager (REM) agent cluster 105 having a REM agent 110 coupled to an AE 115. The REM cluster 105 is coupled to a first memory cache 120 that includes a rule set cache 125 and an I/O data cache 130. The system 100 further includes a data server cluster 135 including a data server 140 and a data access subsystem 145 that is coupled to the data server 140. The system 100 further includes a second memory cache 155 that includes a state information cache 155. The data server 140 is coupled to both the REM agent 110 and the AE 115 in the REM agent cluster 105. The data server 140 is further coupled to the I/O data cache 130 in the first memory cache 120, and to the state information cache 155 in the second memory cache 150. The data server 140 is further coupled to a persisted state information storage database 160, a central condition assessment platform database (CCAP) 170, and a historian database 165. The persisted state information storage database 160 stores data persisted from the data server 140 as further described herein. The persisted state information can have multiple data stores (e.g., data stored 161, 162, 163). The historian database 165 stores historic asset data (e.g., data related to turbine fleet operation). The historic asset data can be generated by a computer 175 coupled to an asset 180. The computer 175 moves time series data measured from the asset 180 to the central historian time series database 165. The CCAP database 170 further includes alarms/events based on the condition of the asset 180 and collected by the computer 175.

In exemplary embodiments, the system 100 supports REM in-memory data transfer methods. REM in-memory data transfer is a method in which the first and second caches 120, 150 manage and persist input and output data, state file data, and rule set definition data. The REM in-memory data transfer method also provides the AE 115 the capability of interacting directly with the REM agent 110 and remove the use of expensive file I/O operations.

In exemplary embodiments, the system supports multiple data types that include but are not limited to: 1) time series data for rule input and output; 2) state file data (i.e., information specific to what “state” the asset 180 was in at a last calculation); and 3) the rule set\logic the AE 115 is to use with a given set of time series and state file data. The system 100 processes each of these types of data differently from each other, but implement similar methods to receive the result of managing and providing in-memory data exchange between the REM agent 110 and the AE 115. Each data type can also be stored long term in an appropriate data store (e.g., time series data in data store 161, state file data in data store 162 and rule/set logic data in data store 163). Most recently requested\required data stored is stored in a local cache (e.g., the first memory cache 120). In addition data transfer between the REM agent 110 and the AE 115 can be performed directly (e.g., via web services).

In exemplary embodiments, time series data (i.e., input and output data) is stored in an appropriate storage device (e.g., the I/O data cache 130) that is retrieved or written via the data server 140. The data server 140 retrieves the entire set of input data for running an entire assets rule suite and places the data in the first memory cache 120 for quick and easy access. Upon rule execution the REM agent 110 informs the data server 140 to prepare the set of input data required for a unique asset and rule instance. The REM agent 110 then launches the AE 115 indicating that the data is available directly from REM via in-memory transfer. The AE 115 is then able to directly ask the REM agent 110 via a uniform resource locator (URL) it was given and the REM agent 110 packages and delivers the data to the AE 115 in-memory. Likewise, on completion of rule execution the AE 115 sends the output data (i.e., result data) back to REM agent 110 with the same URL. The cached data set is maintained until the current batch of rules for the asset 180 has completed execution and all output data has been persisted back to the appropriate data store.

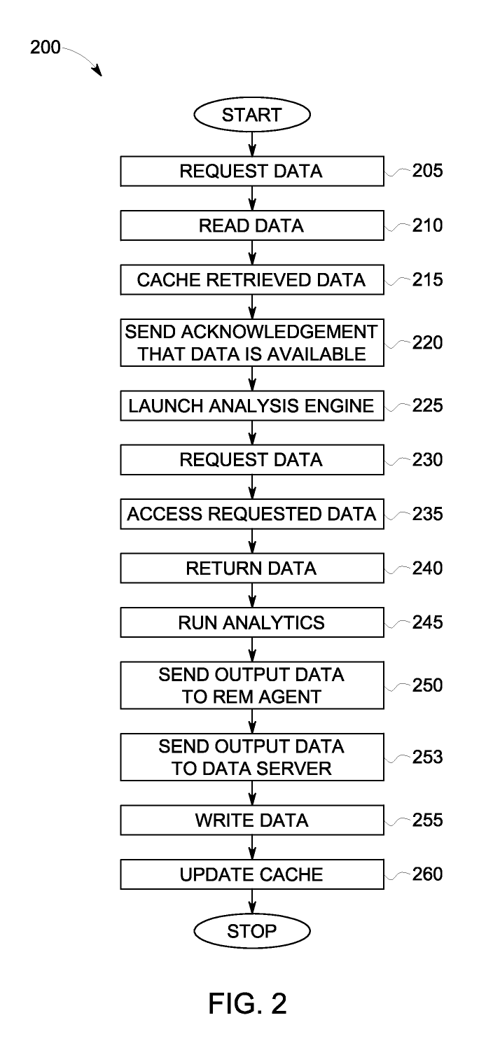

FIG. 2 illustrates a flow chart for a method 200 of in-memory data transfer of input and output time series data in accordance with exemplary embodiments. At block 205, the REM agent 110 requests data from the data server 140. At block 210, the data server 140 reads data from the historian database 165 via the data access subsystem 145. At block 215, the data server 140 caches the retrieved data in the first memory cache 120 (e.g., the I/O data cache 130). At block 220, the data server 140 sends an acknowledgement to the REM agent 110 that the data is available. At block 225, the REM agent 110 launches the AE 115. At block 230, the AE 115 makes a request (e.g., a web service request) for the needed data. At block 235, the REM agent 110 accesses the requested data from the first memory cache 120. At block 240, the REM agent 110 returns the requested data to the AE 115. At block 245, the AE 115 runs analytics. At block 250, the AE 115 sends output data to the REM agent 110. At block 253 the REM Agent 110 sends the data to the data server 140. At block 255, the data server 140 writes data to the historian database 165. At block 260, the data server 140 updates the first data cache 120 with the output data.

In exemplary embodiments, state file data is stored in the state information cache 155 in the second memory cache 150 (e.g., a HyperSQL database (HSQDB) in file mode managed by a JBOSS Application Server product). State files are exchanged by the REM agent 110 passing the AE 115 a URL for which to interact and do in-memory exchange. The REM agent 110, upon receiving state file data, sends the data to the second memory cache 150 for quick retrieval when requested again by the AE 115. Upon adding a new or updating an existing state file the second memory cache 150 persists the data to file by services provided by the data server (e.g., HSQDB services from the JBOSS application server).

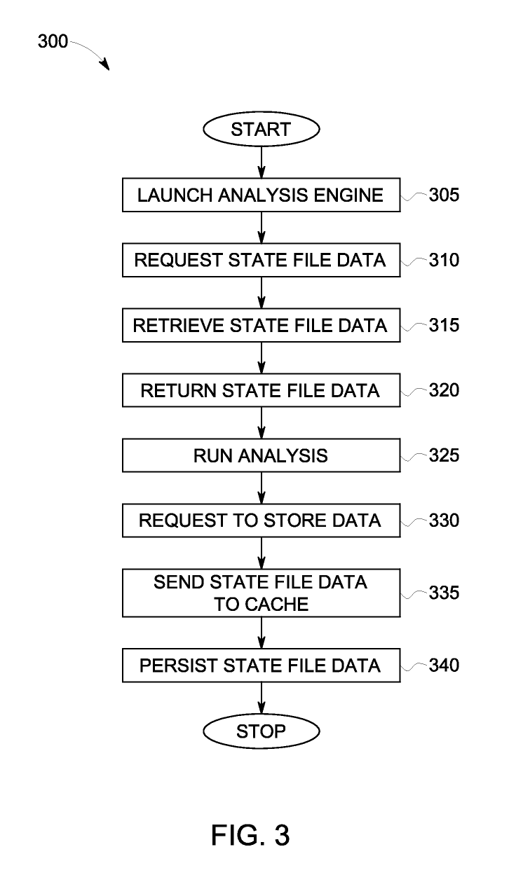

FIG. 3 illustrates a flow chart for a method 300 of in-memory data transfer of state files in accordance with exemplary embodiments. At block 305 the REM agent 110 launches the AE 115. At block 310, the AE 115 makes a request to the data server 140 to retrieve state file data. At block 315, the data server 140 retrieves the state file data from the second memory cache 150 (e.g., the state information cache 155). At block 320, the data server 140 returns the state file data to the AE 115. At block 325, the AE 115 runs an analysis. At block 330, the AE 115 makes a request to the data server 140 to store update state files. At block 335, the data server sends the state file data to the second memory cache 150 to store and persist. If the second memory cache is unavailable, the data server 140 directly persists the state file in the persisted state information database 160.

In exemplary embodiments, rule set logic is passed by the REM agent 110 retrieving the rule set logic from the CCAP database 170 and caching the rule set logic in the first memory cache 120. When the REM agent 110 launches the AE 115, the REM agent 110 provides the URL where the rule logic can be accessed in-memory. Where in the case of input, output and state data there is an in-memory path where the AE 115 returns new or updated data to the REM agent 110 to manage the data persistence. There is no such path for the rule set data because the AE 115 does not make any changes its self to that data.

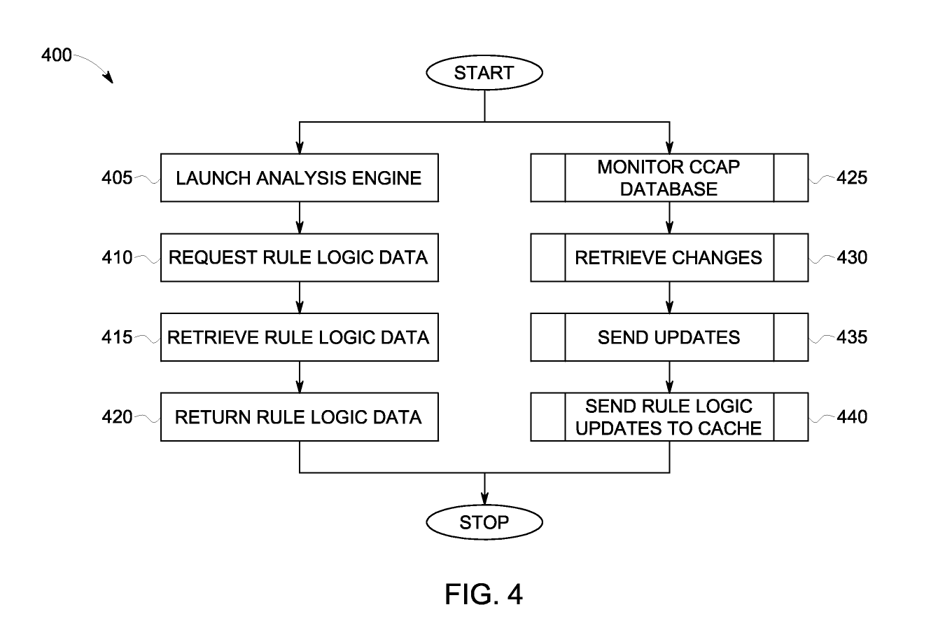

FIG. 4 illustrates a flow chart for a method 400 of in-memory data transfer of rule logic data in accordance with exemplary embodiments. At block 405, the REM agent 110 launches the AE 115. At block 410, the AE 115 makes a request to the REM agent 110 to retrieve rule logic data from the first memory cache 120 (e.g., the rule set cache 125). At block 415, the REM agent 110 directly retrieves the rule set from the first memory cache 120. At block 420, the REM agent 110 returns the rule logic data to the AE 115. In exemplary embodiments, the data server 140 runs in the background, constantly monitoring and updating the REM agent 110 of any rule logic changes as now described. At block 425, the data server 140 monitors the CCAP database 170 for changes to any rule logic. At block 430, the data server 140 retrieves any changes. At block 435, the data server sends any updates to the REM agent 110. At block 440, the REM agent 110 sends rule logic updates to the first memory cache 120.

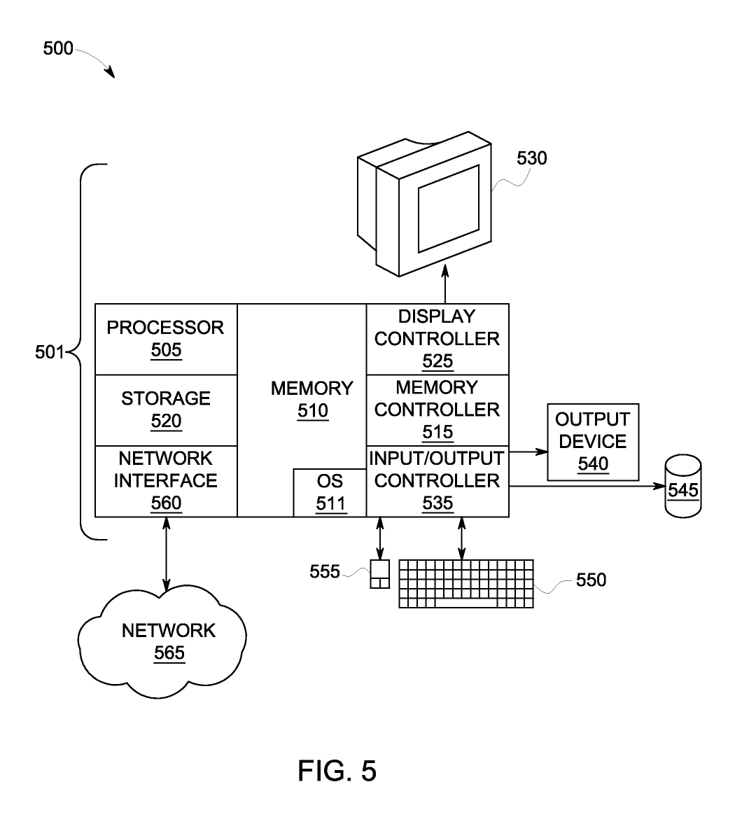

The system 100 can be a part of any suitable computing system as now described. FIG. 5 illustrates an exemplary embodiment of a system 500 for REM in-memory data transfer. The methods described herein can be implemented in software (e.g., firmware), hardware, or a combination thereof. In exemplary embodiments, the methods described herein are implemented in software, as an executable program, and is executed by a special or general-purpose digital computer, such as a personal computer, workstation, minicomputer, or mainframe computer. The system 500 therefore includes general-purpose computer 501.

In exemplary embodiments, in terms of hardware architecture, as shown in FIG. 5, the computer 501 includes a processor 505, memory 510 coupled to a memory controller 515, and one or more input and/or output (I/O) devices 540, 545 (or peripherals) that are communicatively coupled via a local input/output controller 535. The input/output controller 535 can be, but is not limited to, one or more buses or other wired or wireless connections, as is known in the art. The input/output controller 535 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 505 is a hardware device for executing software, particularly that stored in memory 510. The processor 505 can be any custom made or commercially available processor, a central processing unit (CPU), an auxiliary processor among several processors associated with the computer 501, a semiconductor based microprocessor (in the form of a microchip or chip set), a macroprocessor, or generally any device for executing software instructions.

The memory 510 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 510 may incorporate electronic, magnetic, optical, and/or other types of storage media. Note that the memory 510 can have a distributed architecture, where various components are situated remote from one another, but can be accessed by the processor 505.

The software in memory 510 may include one or more separate programs, each of which comprises an ordered listing of executable instructions for implementing logical functions. In the example of FIG. 5, the software in the memory 510 includes the for REM in-memory data transfer methods described herein in accordance with exemplary embodiments and a suitable operating system (OS) 511. The OS 511 essentially controls the execution of other computer programs, such the for REM in-memory data transfer systems and methods as described herein, and provides scheduling, input-output control, file and data management, memory management, and communication control and related services.

The for REM in-memory data transfer methods described herein may be in the form of a source program, executable program (object code), script, or any other entity comprising a set of instructions to be performed. When a source program, then the program needs to be translated via a compiler, assembler, interpreter, or the like, which may or may not be included within the memory 510, so as to operate properly in connection with the OS 511. Furthermore, the for REM in-memory data transfer methods can be written as an object oriented programming language, which has classes of data and methods, or a procedure programming language, which has routines, subroutines, and/or functions.

In exemplary embodiments, a conventional keyboard 550 and mouse 555 can be coupled to the input/output controller 535. Other output devices such as the I/O devices 540, 545 may include input devices, for example but not limited to a printer, a scanner, microphone, and the like. Finally, the I/O devices 540, 545 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like. The system 500 can further include a display controller 525 coupled to a display 530. In exemplary embodiments, the system 500 can further include a network interface 560 for coupling to a network 565. The network 565 can be an IP-based network for communication between the computer 501 and any external server, client and the like via a broadband connection. The network 565 transmits and receives data between the computer 501 and external systems. In exemplary embodiments, network 565 can be a managed IP network administered by a service provider. The network 565 may be implemented in a wireless fashion, e.g., using wireless protocols and technologies, such as WiFi, WiMax, etc. The network 565 can also be a packet-switched network such as a local area network, wide area network, metropolitan area network, Internet network, or other similar type of network environment. The network 565 may be a fixed wireless network, a wireless local area network (LAN), a wireless wide area network (WAN) a personal area network (PAN), a virtual private network (VPN), intranet or other suitable network system and includes equipment for receiving and transmitting signals.

If the computer 501 is a PC, workstation, intelligent device or the like, the software in the memory 510 may further include a basic input output system (BIOS) (omitted for simplicity). The BIOS is a set of essential software routines that initialize and test hardware at startup, start the OS 511, and support the transfer of data among the hardware devices. The BIOS is stored in ROM so that the BIOS can be executed when the computer 501 is activated.

When the computer 501 is in operation, the processor 505 is configured to execute software stored within the memory 510, to communicate data to and from the memory 510, and to generally control operations of the computer 501 pursuant to the software. The for REM in-memory data transfer methods described herein and the OS 511, in whole or in part, but typically the latter, are read by the processor 505, perhaps buffered within the processor 505, and then executed.

When the systems and methods described herein are implemented in software, as is shown in FIG. 5, the methods can be stored on any computer readable medium, such as storage 520, for use by or in connection with any computer related system or method.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In exemplary embodiments, where the for REM in-memory data transfer methods are implemented in hardware, the for REM in-memory data transfer methods described herein can implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Technical effects include decreasing the time to recognize events by freeing the AE to focus on its core value performing analytics and notification of events. The systems and methods described herein also dramatically reduce the possibility of file I/O failures that inhibit analytics from running at all. The systems and methods described herein provide a mechanism for transferring required data in-memory directly between REM agent and the Analysis Engine, removing the need for interacting with file storage systems outside of applications in the system.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A rule engine manager (REM) in-memory data transfer system, comprising:
a REM cluster;
a first memory cache coupled to the REM cluster;
a data server cluster coupled to the REM cluster; and
a second memory cache coupled to the data server cluster.

2. The system as claimed in claim 1 wherein the REM cluster comprises:
a REM agent; and
an analysis engine coupled to the REM agent.

3. The system as claimed in claim 2 wherein the data server cluster comprises:
a data server coupled to the REM agent and the analysis engine; and
a data access subsystem coupled to the data server.

4. The system as claimed in claim 1 wherein the first memory cache comprises a rule set cache.

5. The system as claimed in claim 1 wherein the first memory cache comprises an input/output (I/O) data cache.

6. The system as claimed in claim 1 wherein the second memory cache includes a state information cache.

7. The system as claimed in claim 6 further comprising a persisted state information database coupled to the state information cache and to the data server cluster.

8. The system as claimed in claim 1 further comprising a condition assessment platform (CCAP) database coupled to the data server cluster.

9. The system as claimed in claim 1 further comprising a historian database coupled to the data server cluster.

10. The system as claimed in claim 9 further comprising:
a computer coupled to the historian database; and
an asset coupled to the computer.

11. A data transfer method, comprising:
transferring time series data between a rule engine manager (REM) and an analysis engine (AE);
transferring state file data between the REM and the AE; and
transferring rule logic data between the REM and the AE.

12. The method as claimed in claim 11 wherein the time series data, the state file data and the rule logic data are transferred in-memory.

13. The method as claimed in claim 11 wherein transferring time series data between the REM and the AE comprises:
requesting the time series data;
receiving the time series data; and
analyzing the time series data.

14. The method as claimed in claim 11 wherein transferring state file data between the REM and the AE comprises:
requesting the state file data;
analyzing the state file data; and
sending a request to store update state file data.

15. The method as claimed in claim 11 wherein transferring rule logic data between the REM and the AE comprises:
requesting rule logic data; and
receiving rule logic data.

16. A computer program product for transferring data, the computer program product including a non-transitory computer readable medium storing instructions for causing a computer to implement a method, the method comprising:
transferring time series data between a rule engine manager (REM) and an analysis engine (AE);
transferring state file data between the REM and the AE; and
transferring rule logic data between the REM and the AE.

17. The computer program product as claimed in claim 11 wherein the time series data, the state file data and the rule logic data are transferred in-memory.

18. The computer program product as claimed in claim 11 wherein transferring time series data between the REM and the AE comprises:
requesting the time series data;
receiving the time series data; and
analyzing the time series data.

19. The computer program product as claimed in claim 11 wherein transferring state file data between the REM and the AE comprises:
requesting the state file data;
analyzing the state file data; and
sending a request to store update state file data.

20. The computer program product as claimed in claim 11 wherein transferring rule logic data between the REM and the AE comprises:
requesting rule logic data; and
receiving rule logic data.
